(19) United States
(12) Patent Application Publication
(10) Pub. No.: US 2013/0011530 A1
(43) Pub. Date: Jan. 10, 2013

(54) Modular mold with connectors

(76) Inventors: Andrea Rae Wolf, West Harrison, IN (US); Travis Rex Wolf, West Harrison, IN (US)

(21) Appl. No.: 13/135,475

(22) Filed: Jul. 7, 2011

(51) Int. Cl. A23G 9/26; A23G 9/08; A23P 1/10

(52) U.S. Cl. 426/241; 249/97

(57) ABSTRACT

Modular mold unit and space-saving modular mold assembly, method, and article of manufacture for forming and preparing frozen confections that allow a quick release of the frozen confections from the mold by a microwave oven, wherein the mold unit is made of plasticizer-free, unadulterated, nonrecycled, heat-stable, microwave-transmissible plastic. The modular mold unit comprises a container member and a detachable lid member, wherein said container member comprises attachment means comprising lock-and-key mating or coupling connector members that are used to firmly and removably connect a plurality of modular mold units to one another to form an assembly of mold units, and wherein said detachable lid member has a stick member that is integrally molded with said lid member. Alternatively, said removable lid member is a stick-supporting lid having a central collar with a longitudinal slot opening to frictionally hold a separate wooden or plastic stick.

### BACKGROUND OF THE INVENTION

1. Field of the Invention

This invention relates to a modular mold unit and space-saving modular mold assembly for forming and preparing a frozen confection, especially frozen confection on a stick, such as flavored ice and ice cream, that allow a quick release of the frozen confection from the mold by microwave radiation, said mold unit and mold assembly being made of plasticizer-free, unadulterated, nonrecycled, heat-stable, microwave-transmissible plastic. This invention also relates to a method using said mold unit and mold assembly to produce said frozen confection including the step of using microwave radiation for heating to quickly and conveniently release said confections from said mold.

2. Description of the Related Art

The first popsicle is disclosed in U.S. Pat. No. 1,505,592 issued Aug. 19, 1924 to F. W. Epperson, which discloses a method for making frozen confections on a stick using test tubes to contain liquid syrup and a wooden stick. When the freezing operation is completed the container is immersed in luke warm water to loosen the frozen confection from the container to remove the confection from the container. A negative of such mold is such glass test tubes can be accidentally and easily broken or shattered.

Subsequently, there are other disclosures of mold assemblies for preparing frozen confections at home. U.S. Pat. No. 2,946,207 issued Jul. 26, 1960 discloses a mold assembly consisting of a plurality of individual cups integrally joined together with a web or sheet. Each cup has a lid or cap with a stick-like arm depending therefrom that is immersed in the liquid contained in the cup to support the resulting frozen article when the liquid is frozen in a freezer. Each cap also has a handle situated on the opposite side of the stick-like arm. The integral cups and web are made of resilient plastic material such as polyethylene, polypropylene, polystyrene, and polyvinyl chloride. No instructions are provided for how the frozen confections are to be released from the cups. The risk of the presence of plasticizer in the resilient plastic material is not appreciated.

U.S. Pat. No. 4,239,175 issued Dec. 16, 1980 discloses an improvement over U.S. Pat. No. 2,946,207, wherein each cap that serves to retain any molten liquid is provided with a straw member to allow the molten liquid therein to be drawn off. The mold assembly is formed from a synthetic plastic material. No instructions are provided for how the frozen confections are to be released from the cups except a disclosure that the cap member can be lifted upwardly to remove the frozen product from the cup member. The risk of the presence of plasticizer in the resilient plastic material is not appreciated.

U.S. Pat. No. 5,354,191 issued Oct. 11, 1994 discloses a variation from U.S. Pat. No. 4,239,175, with the mold assembly comprising a planar tray member wherein the cups can either be integral parts of the tray member or be removably mounted in the openings of the tray member, and wherein the caps (or covers) of the cups also include passageway arrangement to draw off any melted liquid. The mold assembly can be made from any suitable synthetic plastic materials. For consumption, the cover and holder assemblies can each be removed with the frozen food product from its associated container by heating, such as applying hot water to the outer surface of the container.

In the hereinabove U.S. Pat. Nos. 2,946,207, 4,239,175, and 5,354,191, there is no anticipation of heating by microwave radiation nor indication of concern of a potential of leaching or migrating of toxic plasticizers from the plastic to the comestible confection, especially upon heating, especially heating under microwave radiation, nor a potential of degradation of plastic that can result upon heating, especially heating under microwave radiation, to form toxic by-product ingredients that would contaminate the comestible confection.

U.S. Pat. No. 3,411,463 issued Nov. 19, 1968 discloses a mold assembly comprising a rigid plastic tray having openings to hold a series of metallic cups, each cup is covered by a flexible stick-supporting cap having a slot that is centrally located to frictionally hold a wooden stick. The flexibility of the plastic cap allows it to be snapped to the rim of the cup. The cups are filled with confection liquid then inserted in the openings of the tray, and the whole assembly is placed in the freezer compartment of a home refrigerator to be frozen. It is disclosed that the frozen comestible can be separated from its cup by subjecting the latter for a short period of time to the heat of a human hand. The metallic cups do not contain plasticizer but they are not microwave-transmissible to allow heating by microwave.

U.S. Pat. No. 6,301,919 issued Oct. 16, 2001 discloses a machine that can be used by children to make ice cream bars on a stick wherein the machine includes metal containers to receive and hold ice cream bar mix.

Homemade ice cream bars or popsicles are frozen in the freezer compartment of a home refrigerator, and the frozen bars are extracted from the molds by warming the outside of the molds to melt the interface of the frozen bars and molds then pulled from the molds using the inserted sticks. The common method for warming the molds is to place them upside down or sideways under a stream of hot or warm tap water. A commercially available mold assembly that comprises eight cups integrally joined together with a plate that is produced by Arrow Plastic Manufacturing Co., Elk Grove, Ill. 60007, has the following instructions: “Fill to just below top. Insert sticks and place in freezer. To remove, run water on outside of pops.” This heating method is not efficient because the water flow and coverage are not uniform, thus the hot water is not applied uniformly. Furthermore, the walls of the plastic molds are heat-insulating, so that it usually takes some time to thaw the surface of the frozen bars. Also, the water flow is not easily controlled, such that water spilling into the inside of the molds to contaminate the comestible bars can occur.

Integral trays disclosed in the above U.S. Pat. Nos. 2,946,207 and 4,239,175, and the mold assembly that is provided by the Arrow Plastic Manufacturing Co. do not allow the flexibility of making the exact number of frozen confections that are needed, and thus they can undesirably occupy more room in the freezer compartment than needed. For example, using a tray with eight cups to make four frozen confection units leaves four empty cups that take extra room. To make ten frozen confection units required two trays with even more room that is wasted. Even the mold assemblies with individual cups that are disclosed in U.S. Pat. Nos. 3,411,463 and 5,354,191 can unnecessarily take extra room in the freezer compartment, because the tray requires the full space even when less than maximum number of individual cups are used with the tray.

It is therefore an object of the present invention to provide an improved space-saving modular mold unit and mold assembly that allow the preparation of an exact number of frozen confections that are needed without taking extra space in the freezer compartment of a home refrigerator.

It is also an object of the present invention to provide an improved mold for forming and preparing frozen confections that allows heating in a microwave oven for a quick and convenient release of the frozen confections that also avoids the step of releasing the confections by hot running water that is inconvenient and may contaminate the frozen confections.

Other objects and advantages will become apparent and understood by reference to the following detailed description of the preferred embodiments that follows.

### SUMMARY OF THE INVENTION

The present invention relates to a modular mold unit and space-saving modular mold assembly for making frozen confections, wherein each said modular mold unit comprises a container member and a removable and reclosable lid member, wherein said container member comprises attachment means comprising two or four lock-and-key mating or coupling connector members that are used to firmly and removably connect a plurality of said modular mold units to one another to form an assembly of mold units, wherein said mold assembly allows the preparation of an exact number of frozen confections on a stick that are needed without causing extra dead space in the freezer compartment of a home refrigerator. The container member of the modular mold unit comprises an opening on the top side, wherein said opening is covered by a removable lid member, wherein said lid member comprises a raised ridge that fits snuggly with said opening, and said lid member further comprises an interior stick-like anchor to support the frozen confection and an exterior handle, wherein said interior stick-like anchor and said exterior handle are integrally molded to said lid.

This invention also relates to modular mold units and mold assembly for forming and preparing frozen confections on a stick, that allow a quick release of the frozen confections by microwave radiation, said mold units being made of plasticizer-free, unadulterated, nonrecycled, heat-stable, microwave-transmissible plastic.

In another embodiment of the present invention, the removable lid member is a stick-supporting lid having a central collar with a longitudinal slot that is centrally located in said lid to frictionally hold and support a wooden or plastic stick and divides said stick into a handle and an anchor, and wherein said lid member is optionally made of semi-rigid silicone rubber.

This invention also relates to a method of producing frozen confections, such as flavored ice and ice cream, including the step of placing liquid confection material in the receptacles of the modular mold units of the mold assembly, with said mold units and mold assembly being made of plasticizer-free, nonrecycled, heat-stable, microwave-transmissible plastic; placing the molds in a freezer compartment to freeze the liquid, and using microwave radiation to quickly and conveniently release said frozen confections from said molds.

This invention also relates to an article of manufacture that provides frozen confection modular mold units as described above, and that optionally provides other parts such as wooden or plastic sticks, and instructions for use; and wherein such modular molds can carry an indicia that, e.g., either identifies the molds, describes their convenient use, etc. It is important to provide instructions that indicate that the molds can safely be used in a microwave oven for quickly, conveniently, and hygienically releasing the confections from the molds, to provide the user with an appropriate incentive for using the invention.

In this document, the term “about” is presumed to modify all numerical values, it being understood that exact numerical values are not required unless it is specifically stated.

### BRIEF DESCRIPTION OF THE DRAWINGS

FIG. 1 is an exploded perspective view of an embodiment of a modular mold unit of the present invention, comprising a container member and a removable lid member, wherein the container member has two female connector members on two consecutive faces and two mating male connector members on the two remaining consecutive faces, and wherein the removable lid member comprises a lid body with a stick-like arm and a handle situated on the opposite side of the stick-like arm, wherein the stick-like arm and the hand are integrally molded to the lid member;

FIG. 2 is a cross-sectional view of the removable lid member of FIG. 1 showing the broad side view of the lid member, taken along line 2-2 of FIG. 1;

FIG. 3 is a cross-sectional view of the removable lid member of FIG. 1 showing the narrow side view of the lid, taken along line 3-3 of FIG. 1;

FIG. 4 is the overhead view of the container member of FIG. 1; showing the oval top side, two consecutive female connector members, and two consecutive male connector members;

FIG. 5 is an overhead view of an assembly of four modular mold units of FIG. 1 wherein the modular mold units are firmly held to one another by female coupling connector members attached to male connector members;

FIG. 6 is an exploded perspective view of another embodiment of a modular mold unit of the present invention, comprising a tapered circular cylindrical container member and a removable lid member, wherein the container member comprises a round top side, and two female mating connector members and two male mating connector members at the upper portion of the container, and wherein the removable lid member has a lid body comprising a central collar with a longitudinal slot to hold a wooden or plastic stick, with one end of the stick serving as an anchor to hold the frozen confection and the other end serving as a handle;

FIG. 7 is a cross-sectional view of the removable lid member of FIG. 6 showing the broad view of said lid member taken along line 7-7 of FIG. 6, wherein said lid member comprises the central collar with the longitudinal slot holding the stick; and

FIG. 8 is an overhead view of the container member of the modular mold unit of FIG. 6 showing the two female mating connector members and two male mating connector members integrally molded to the round top side of the circular top side. The cavity reveals the inner side of the circular bottom side, and the inner side of the outer tapered circular cylindrical side.

These drawings are not drawn to scale and are intended for illustrative purposes only.

### DETAILED DESCRIPTION OF THE INVENTION

The present invention relates to a modular mold unit and a space-saving modular mold assembly for forming and preparing frozen confections, said mold unit and mold assembly allow the preparation of an exact number of frozen confections on a stick that are needed without taking any extra space in the freezer compartment of the home refrigerator. Preferably said mold and mold assembly allow a quick release of the frozen confections from the mold by microwave radiation, preferably a home microwave oven, wherein said mold is made of microwave-safe plastic comprising plasticizer-free, unadulterated, nonrecycled, heat-stable, microwave-transmissible plastic.

“Modular mold unit,” as used herein, means that each individual mold unit comprises a container member or cup having attachment means, comprising two or four lock-and-key mating or coupling connector members, that are used to firmly and removably connect a plurality of modular mold units to one another to form an assembly of mold units, wherein each said modular mold has an opening on the top side covered by a removable lid member or cap, and wherein said modular mold is not part of a mold assembly that is either (a) integrally joined together with a tray (or a web or sheet) that has fixed and predetermined dimensions, such as those that are disclosed in U.S. Pat. Nos. 2,946,207 issued July 26, 1960 to Hulterstrum, 4,239,175 issued Dec. 16, 1980 to Straubinger, and 5,354,191 issued Oct. 11, 1994 to Bobis, all said patent are incorporated herein by reference, or (b) a part of a mold assembly wherein said mold assembly comprises a flat rigid plastic tray (or top) with spaced feet for supporting said tray and having fixed and predetermined dimensions and having openings to hold a plurality of said mold, such as those that are disclosed in U.S. Pat. Nos. 3,411,463 issued Nov. 19, 1968 to Moseres, and 5,354,191 issued Oct. 11, 1994 to Bobis, all said patent are incorporated herein by reference. “Microwave-safe plastic,” as used herein, means plasticizer-free, unadulterated, nonrecycled, heat-stable, microwave-transmissible plastic. “Plasticizer free,” as used herein, means that the plastic material used in the present invention does not contain plasticizers, which are additives to plastics to make them more flexible. Plasticizers can be harmful to the health, even carcinogenic, when consumed, even at low levels. Plasticizers are not bound to plastics and can migrate out of plastic, especially by heating, more especially by heating by microwave which is essential for the method of heating of the present invention, and contaminate the confection to be consumed. “Unadulterated,” as used herein, means that the plastic material used in the present invention is not blended with other types of plastics or recycled plastics. “Nonrecycled,” as used herein, means that the plastic used in the present invention does not contain any recycled plastic, which is plastic material that had been used before and is recycled and blended with new plastic. Recycled plastic is mixtures of prior used plastics that are collected from many sources, some of which can contain plasticizers. “Heat-stable,” as used herein, means that the plastic used in the present invention is not degraded by heat. Polymers such as polystyrene and polycarbonate are generally not heat stable and also contain bisphenol A. Polyvinyl chloride plastic normally contains phthalate plasticizer and bisphenol A. “Microwave transmissible,” as used herein, means that the material allows a substantial amount of microwave radiation to pass through. Plastic materials normally are microwave-transmissible except when they are embedded with metallic materials. Metallic molds are generally not microwave-transmissible. Preferred plastic material for use in the present invention include plasticizer-free, unadulterated, and nonrecycled polyethylene terephthalate (polyester), plasticizer-free, unadulterated, and nonrecycled polypropylene, plasticizer-free, unadulterated, and nonrecycled high density polyethylene, plasticizer-free, unadulterated, and nonrecycled low density polyethylene, and semi-rigid silicone rubber. Due to its flexible nature even without containing plasticizer, the semi-rigid silicone rubber is a preferred material to make the lid of the individual mold. For the purpose of this invention, molds made with glass, rubber, latex, or metal are not preferred. Polyvinyl chloride, polystyrene, and polycarbonate should be avoided.

The consumer has endured for many years the problems of inconvenient removal of frozen confections by the use of running water and of the space requirement to store half empty mold assembly in the freezer. It is surprising that heating by microwave radiation still can preserve the integrity of the frozen confection bars, and this novel heating method for releasing frozen confection bars has provided more convenience and safety in the preparation of frozen confections for home consumption.

Thus this present invention relates to a modular mold unit for making frozen confection comprising a container member (or cup) and a removable (or detachable) lid member (or cap), wherein said container member comprises a receptacle with an opening on the top side to receive and hold a flavored liquid syrup to be frozen, and attachment means comprising and two or four lock-and key connector members on the body side, wherein said connector members are used to firmly and removably connect a plurality of said modular mold units to one another to form an assembly of mold units, wherein said mold assembly allows the preparation of an exact number of frozen confections on a stick that are needed without causing extra dead space in the freezer compartment of a home refrigerator, wherein said opening on the top side of said modular unit is covered by said removable lid member, wherein said lid member comprises a raised ridge that fits snuggly over said opening of the, an interior stick-like anchor (or arm) depending from said lid member to support the frozen confection, and an exterior handle-like arm situated on the opposite side of the stick-like anchor from the lid member, said anchor and said arm are integrally molded to said lid member, and wherein said container member and said lid member are made of plasticizer-free, unadulterated, nonrecycled, heat-stable, microwave-transmissible plastic. Alternatively, said removable lid member is a stick-supporting lid having a central collar with a longitudinal slot that is centrally located in said lid to frictionally hold a separate elongated wooden or plastic stick, preferably a stick with round ends, and to divide said stick into a handle and an anchor, and wherein said plastic stick is made of microwave-safe plastic comprising plasticizer-free, unadulterated, nonrecycled, heat-stable, microwave-transmissible plastic, and wherein said lid member is optionally made of semi-rigid silicone rubber.

Non-limiting examples of lock-and-key coupling connector members that are suitable for use as attachment means to form a mold assembly of the present invention include mating loop and hook Velcro-type strips, multiple rib and groove Ziploc™-type strips, stud and cavity Lego™ type plates, or female and male coupling connector members. Female and male coupling connector members are the preferred coupling connector members. The coupling connector members are attached to the sides of the container members of the modular mold units, and allow the mold units to be firmly linked to one another to form a one-dimension or a two-dimension mold assembly. The mold assembly of the present invention allows the preparation of an exact number of frozen confections that are needed without taking extra space in the freezer compartment of a home refrigerator. Furthermore, this mold assembly allows the removal and heating of only the exact number of confection units that are needed. The number of unused frozen confections in the intact modular mold units can be restored in the freezer compartment with a reduced volume.

In one embodiment of the present invention, the modular mold unit comprises a tapered ovoid cylindrical container member and a removable lid member. The container member comprises a tapered ovoid cylindrical receptacle body with two opposing broad side aspects and two opposing narrow side aspects, an oval bottom side, and an oval top side comprising a rim with an outer edge and an inner edge, wherein said inner edge delineates the opening of cavity that receives and holds the liquid syrup to be frozen. Two vertical female coupling connector members are integrally molded to the two proximal aspects of the receptacle, while two vertical male coupling connector members are integrally molded to the other two proximal aspects. The vertical female connector members and male connector members are positioned at the upper portion of the side of the container and are used to firmly and removably connect a plurality of modular mold units to one another to form a one-dimension or a two-dimension assembly of mold units that, when the receptacles are charged with liquid syrup, is placed in a freezer compartment to produce frozen confections. The removable lid member comprises the lid body with an oval edge that fits with the outside edges of rim of the container. At its bottom side, the lid member has a raised ridge that fits snuggly with the inside edge of the rim of the container member. Integrally molded to the lid body are an interior elongated stick member (or anchor) and an exterior elongated member (or handle). The interior anchor which can be flat or have indentations or transverse ridges must be sufficiently long to enable the frozen confection to be formed thereon and also have sufficient strength to hold a frozen confection while it is being consumed. The exterior handle, which can be flat or other configurations (such as having indentations or transverse ridges), enables the consumer to grip and hold the lid member with the frozen confection thereon while the frozen confection is being consumed. The modular mold unit is made using plasticizer-free, unadulterated, nonrecycled, heat-stable, microwave-transmissible plastic to allow convenient heating in a microwave oven for a quick release of the frozen confections from the mold. The detachable lid member can alternatively be a stick-supporting lid, wherein the lid body comprises a central collar having a longitudinal slot that frictionally holds a separate elongated flat stick, preferably a stick with round ends, and divides said stick into an exterior portion serving as the handle and an interior portion serving as the anchor to hold the frozen confection. The stick can be made of wood or molded microwave safe plastic. The lid member is made of microwave safe plastic, preferably of semi-rigid silicone rubber, that allows it to fit closely to the rim of the opening of the container member. The preferred lid that is made of semi-rigid silicone rubber can also better enable the vertical slot opening of the central collar to grip the inserted stick and allows a snuggly fitting of the stick into the slot opening.

In another embodiment of the present invention, the modular mold unit comprises a tapered circular cylindrical container member and a round removable lid member. The container member comprises a tapered circular cylindrical receptacle, with a tapered circular cylindrical side, a round bottom side, and a round top side comprising a circular rim with an outer edge and an inner edge. Two vertical female coupling connector members and two vertical male coupling connector members are consecutively molded at equidistance around the outer edge of the receptacle. The coupling connector members are used to firmly and removably connect a plurality of modular mold units together to form a one-dimension or two-dimension assembly of mold units. The container member of the modular mold unit is preferably made of plasticizer-free, unadulterated, nonrecycled, heat-stable, microwave-transmissible plastic to allow convenient heating in a microwave oven for a quick release of the frozen confections from the mold.

The present invention also relates to a mold assembly comprising a plurality of modular mold units that are firmly attached to one another by the attachment means to form a one-dimension or two-dimension assembly of mold units.

The present invention also relates to an article of manufacture comprising the mold assembly described hereinabove, optionally a plurality of wooden or plastic sticks, and optionally instructions for use.

The instructions for use provide information including one or more of: the molds can be used to save space in the freezer compartment; the molds can be safely used in a microwave oven for quickly, conveniently, and hygienically releasing the confections from the molds; and/or the way to determine the length of time needed to heat the mold units in a microwave oven; wherein said instructions for use are printed on one or more of: the package; the accompanying instruction flyer; and/or communicated via print and/or electronic mass media: newspapers, magazines, radio, television, internet, circulars, and the like, and wherein said instructions can be in words, or illustrative images and/or icons including in combination with words.

The present invention also relates to a method for producing of frozen confections that allows the preparation of an exact number of frozen confections on a stick that are needed without causing extra dead space in the freezer compartment of a home refrigerator, and that allows a quick, hygienic, and convenient release of the frozen confections by a microwave oven, said method includes the steps of:
(1) providing a plurality of modular mold units described herein above, wherein each said mold unit comprises a removable lid member comprising either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor;
(2) hooking the desired number of modular mold units to one another using the lock-and key attachment means to form an assembly of mold units;
(3) inserting and securing a flat plastic or wooden stick into the slot opening of the central collar of each lid member if the lid provides said slot opening, and dividing said stick into a handle and an anchor,
(4) placing liquid confection material into the receptacles of the mold units;
(5) snuggly fitting the lids over the openings of the receptacles;
(6) placing the assembly of filled mold units into a freezer and waiting until the liquid confection material is frozen;
(7) removing the assembly of mold units containing the frozen confections from the freezer, unhooking and setting aside the desired number of mold units containing the frozen confections for immediate consumption;
(8) returning the smaller assembly of unused units to the freezer compartment; and
(9) heating the frozen confections in the set-aside molds using a microwave oven to quickly and conveniently thaw the outer layer of the frozen confections to release said frozen confections from the molds.

The heating time needed to heat the mold units in the microwave oven to release and remove the frozen confections varies depending on the power of the microwave oven and on the number of frozen confections that are in the molds depends on the power of the microwave oven and the size of the frozen bars. Normally the required heating time for each individual mold unit is in the range of from at least about 2 seconds, at least about 4 seconds, at least about 5 seconds and up to about 20 seconds, up to about 15 seconds, up to about 10 seconds. Heating several mold units at the same time requires the multiple or slightly less of the individual heating times. When using the article of manufacture of the present invention for the first time, a consumer may need to determine the heating time that is appropriate with his or her particular microwave oven.

Some embodiments of the invention will now be described by way of example hereinafter with reference to the drawings. Similar reference numbers denote corresponding features throughout the drawings. The elements of one embodiment can be combined with those of other elements, or can be used alone.

Those skills in the art will recognize that other forms of this general type of molds can be used without departing from the scope of the present invention.

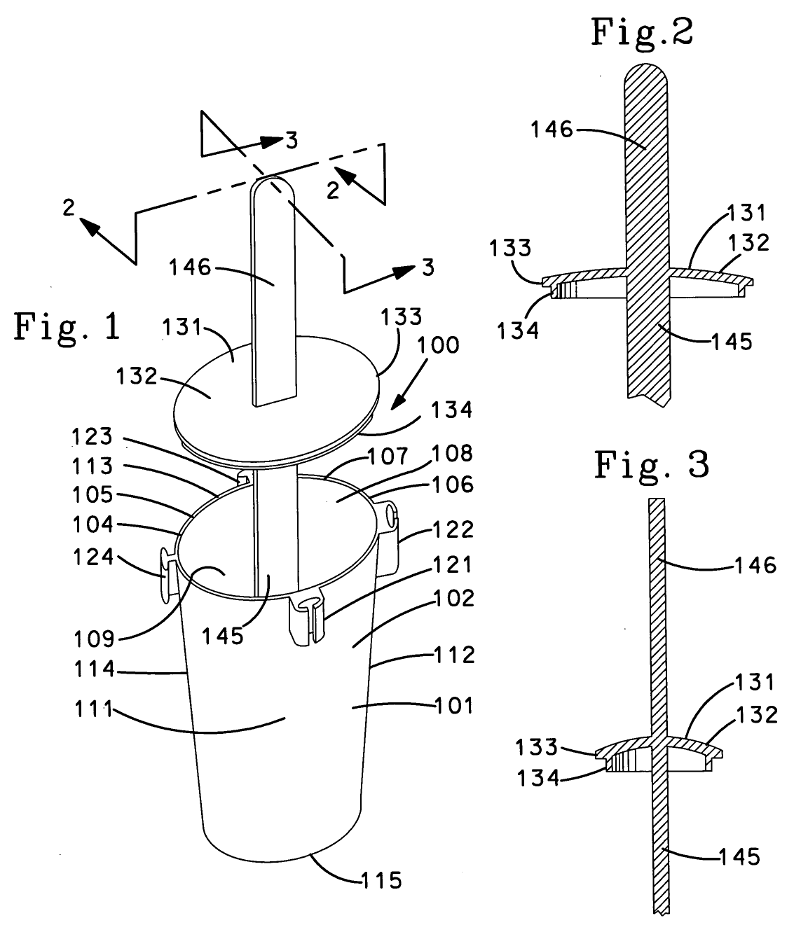

FIG. 1 is an exploded perspective view of an embodiment of a modular mold unit of the present invention, said modular mold unit 100 comprises the container member 101 and a removable lid member 131. The container member 101 comprises a tapered ovoid cylindrical receptacle 102 with two opposing broad side aspects 111 and 113, and two opposing narrow side aspects 112 and 114, an oval bottom side 115, and an oval top side 104 comprising rim 105 with outer edge 106 and inner edge 107, wherein said inner edge 107 delineates the opening 108 of cavity 109 that receives and holds the liquid syrup to be frozen. Two vertical female coupling connector members 121 and 122 are integrally molded to the two proximal aspects 111 and 112, while two vertical male coupling connector members 123 and 124 are integrally molded to the two proximal aspects 113 and 114. The vertical female connector members 121 and 122 and male connector members 123 and 124 are positioned at the upper portion of receptacle 102 and are used by the lock-and-key mechanism to firmly and removably connect a plurality of modular mold units 102 together to form an assembly of mold units that is placed into a freezer compartment to produce frozen confections, when the receptacles are charged with flavored liquid syrup. The removable lid member 131 comprises the lid body 132 with an oval edge 133 that fits with the outside edges of rim 106 of the container 101 at the vertical top side 104. At its bottom side, lid member 131 has the raised ridge 134 that fits snuggly with the inside edge 107 of rim 105 of container member 101. Integrally molded to the lid body 132 are an interior elongated stick member (or anchor) 145 and an exterior elongated handle member 146. The interior anchor 145 which can be flat (as shown) or have indentations or transverse ridges (not shown) must be sufficiently long to enable the frozen confection to be formed thereon and also have sufficient strength to hold a frozen confection while it is being consumed. The exterior handle 146, which can be flat (as shown) or other configurations (such as having indentations or transverse ridges, not shown), enables the consumer to grip and hold the lid member 131 with the frozen confection thereon while the frozen confection is being consumed. Preferably the modular mold unit is made of plasticizer-free, unadulterated, nonrecycled, heat-stable, microwave-transmissible plastic to allow convenient heating in a microwave oven for a quick and convenient release of the frozen confections from the mold.

FIG. 2 is a cross-sectional view of the removable lid member 131 of FIG. 1 showing the broad side view of the lid, taken along line 2-2 of FIG. 1, with the lid body 132 having edge 133 and ridge 134, and wherein the anterior anchor 145 and exterior handle 146 are integrally molded to lid body 132.

FIG. 3 is a cross-sectional view of the removable lid member 131 of FIG. 1 showing the narrow side view of the lid, taken along line 3-3 of FIG. 1, with the lid body 132 having edge 133 and ridge 134, and wherein the anterior anchor 145 and exterior handle 146 are integrally molded to lid body 132.

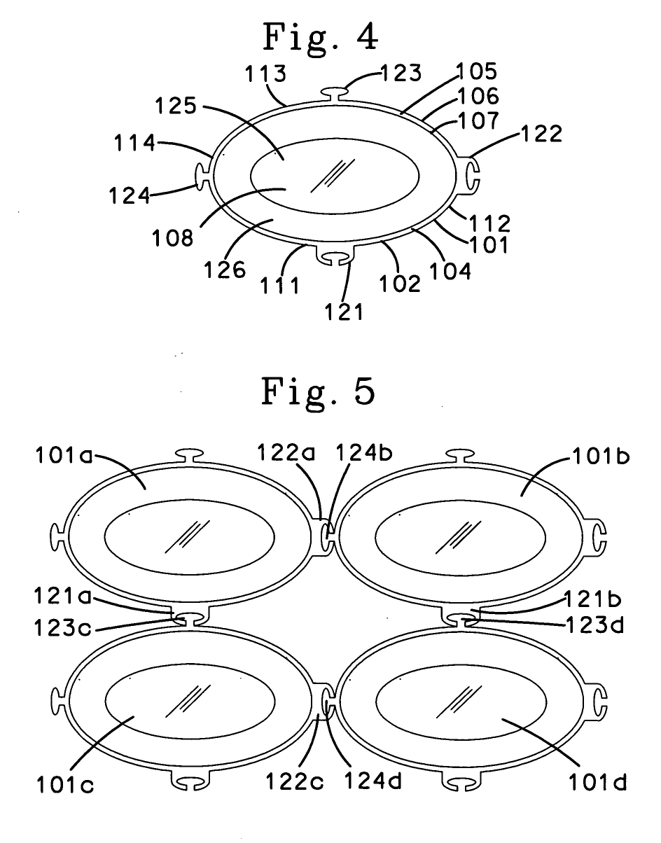

FIG. 4 is an overhead view of the container member 101 of the modular mold unit of FIG. 1 showing the oval top side 104 comprising oval rim 105 with outer edge 106 and inner edge 107, and with the lid member 131 being removed. The cavity 108 reveals the oval inner side 125 of the oval bottom side 204, and the inner side 126 of the tapered oval cylindrical receptacle 102. Also shown are female coupling connector members 121 and 122, and male coupling connector members 123 and 124, which are molded to aspects 111, 112, 113, and 114, respectively.

FIG. 5 is an overhead view of an assembly of a plurality of modular mold units of FIG. 1 wherein the modular mold units (four units in this case, from 101a through 101d) are firmly held together by female coupling connector members 221 to male connector members 223 and female connector members 222 to male connector members 224.

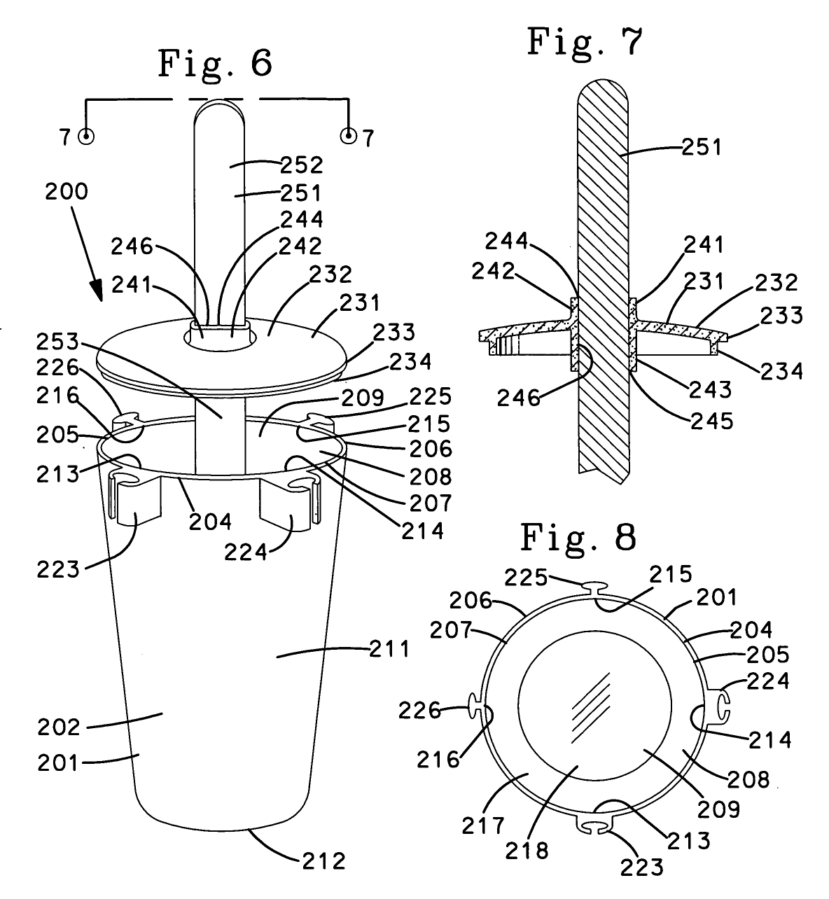

FIG. 6 is an exploded perspective view of another embodiment of a modular mold unit of the present invention, said modular mold unit 200 comprises the container member 201 and a removable lid member 231. The container member 201 comprises a tapered circular cylindrical receptacle 202 with side 211, a round bottom side 212, and a round top side 204 comprising rim 205 with outer edge 206 and inner edge 207, wherein said inner edge 207 delineates the opening 208 of cavity 209 that receives and holds the liquid syrup to be frozen. The outer edge 206 is marked by four points 213, 214, 215, and 216, said four points 213, 214, 215, and 216 are equidistant around the outer edge 206 (with arc 213-214, 214-215, 215-216, and 216-213 all being equal). Two vertical female mating connector members 223 and 224 are integrally molded to the top side 204 at two proximal points 213 and 214, and two vertical male mating connector members 225 and 226 are integrally molded to the two proximal points 215 and 216 The vertical female connector members 223 and 224 and male connector members 225 and 226 are thus positioned at equidistance around the upper portion of the side of receptacle 202 and are used to firmly and removably connect a plurality of modular mold units 201 together to form an assembly of mold units that is placed in a freezer compartment to produce frozen confections, when the receptacles are charged with flavored liquid syrup. Preferably the container member 201 of the modular mold unit 200 is made of plasticizer-free, unadulterated, nonrecycled, heat-stable, microwave-transmissible plastic to allow convenient heating in a microwave oven for a quick and convenient release of the frozen confections from the mold. The detachable lid member 231 comprises the lid body 232 with edge 233 that fits with the outside edges of rim 206 of the top side 204 of container 201.

At its bottom side, lid member 231 has the raised circular ridge 234 (inferior to edge 233) that fits snuggly with the inside edge 207 of rim 205 of container 201. Situated centrally on lid 231 is a central collar 241 comprising the exterior portion 242 with opening 244 and interior portion 243 (not shown) with opening 245 (not shown), wherein opening 244 and opening 245 are parts of the longitudinal slot 246 which holds a separate elongated flat stick 251 that comprises an exterior portion 252 serving as the handle and an interior portion 253 serving as the anchor to hold a frozen confection. Stick 251 can be made of wood or molded microwave safe plastic. Lid 231 is preferably made of microwave safe plastic, preferably of semi-rigid silicone rubber, that allows it to fit closely to the rim 205 of opening 208 of container 201. A preferred lid 231 made of semi-rigid silicone rubber can also better enable the vertical slot opening 246 of the central collar 241 to grip the inserted stick 251 and allows a snuggly fitting of stick 251 into the slot opening 246.

FIG. 7 is a cross-sectional view of the removable lid member 231 of FIG. 6 showing the broad side view of the lid, taken along line 7-7 of FIG. 6, wherein the lid body 232 comprises edge 233, ridge 234, and central collar 241, wherein said central collar comprises the exterior portion 242 with opening 244 and interior portion 243 with opening 245, showing the longitudinal side of slot opening 246 that holds the broad side of stick 251.

FIG. 8 is an overhead view of the container member 201 of the modular mold unit of FIG. 6 showing the round top side 204 comprising circular rim 205, outer edge 206, and inner edge 207, wherein said inner edge 207 delineates the opening 208 of cavity 209. The cavity 209 reveals the inner side 217 of the tapered circular cylindrical side 211 and the round inner side 218 of the round bottom side 212. FIG. 8 also shows the female mating connector members 223 and 224 male mating connector members 225 and 226 that are integrally molded to the top side 204 at points 213, 214, 215, and 216, respectively.

The above description discloses, by way of example, some typical embodiments of the present invention. However, persons of ordinary skill in the art are capable of creating numerous modifications within the scope of the claims. Changes in specifics of form and details can be made to the above-described embodiments. The claims and not the examples are the measure of the protected invention.

What is claimed is:

1. A modular mold unit for making frozen confection comprising a container member and a removable and reclosable lid member; wherein said container member has an opening on the top side and attachment means comprising two or four lock-and-key coupling connector members on the body side, wherein said connector members are used to firmly and removably connect a plurality of said modular mold units to one another to form an assembly of mold units, wherein said mold assembly allows the preparation of an exact number of frozen confections on a stick that are needed without causing extra dead space in the freezer compartment of a home refrigerator, wherein said opening on the top side of said modular mold unit is covered by said removable lid member, wherein said removable lid member comprises a raised ridge that fits snuggly over said opening, an interior stick-like anchor to support the frozen confection and an exterior handle, wherein said interior stick-like anchor and said exterior handle are integrally molded to said lid; and wherein said container member and said lid member are made of plasticizer-free, unadulterated, nonrecycled, heat-stable, microwave-transmissible plastic to allow convenient heating in a microwave oven for a quick release of the frozen confections from the mold.

2. The modular mold unit of claim 1, wherein said container member comprises a tapered ovoid cylindrical receptacle with an oval top side comprising an oval opening, a tapered ovoid cylindrical side with two opposing broad side aspects and two opposing narrow side aspects, and an oval bottom side, wherein the attachment means comprises two vertical female coupling connector members which are integrally molded to two proximal aspects of the container, and two vertical male coupling connector members which are integrally molded to the other two proximal aspects of the container, with said vertical female connector members and male connector members being positioned at the upper portion of the side of the container to allow the mold units to be firmly attached to one another to form a two-dimension mold assembly, and wherein said removable lid member is oval and comprises the lid body with an oval raised ridge that fits over the oval opening of the container.

3. The modular mold unit of claim 2, wherein said removable lid member is a stick-supporting lid having a central collar with a longitudinal slot that is centrally located in said lid to frictionally hold and support a separate wooden or plastic stick and to divide said stick into a handle and an anchor, and wherein said lid member is optionally made of semi-rigid silicone rubber.

4. The modular mold unit of claim 1, wherein said container member comprises a tapered circular cylindrical receptacle with a round top side comprising a circular opening, a tapered circular cylindrical side, and a round bottom side, wherein the attachment means comprises two vertical female coupling connector members and two vertical male coupling connector members which are consecutively molded at equidistance around the upper portion of the side of the container, with the two female coupling connector members being proximal to each other and the two male coupling connector members being proximal to each other, to allow the mold units to be firmly attached to one another to form a two-dimension mold assembly, and wherein said removable lid member is circular and comprises the lid body with a circular edge that fits over the circular opening of the container.

5. The modular mold unit of claim 4, wherein said removable lid member is a stick-supporting lid having a central collar with a longitudinal slot that is centrally located in said lid to frictionally hold and support a separate wooden or plastic stick and to divide said stick into a handle and an anchor, and wherein said lid member is optionally made of semi-rigid silicone rubber.

6. The modular mold unit of claim 1 wherein the plasticizer-free, unadulterated, nonrecycled, microwave-transmissible plastic is selected from the group consisting of high density polyethylene, low density polyethylene, polypropylene, polyethylene terephthalate, and semi-rigid silicone rubber.

7. A mold assembly comprising of a plurality of modular mold units of claim 1, wherein the mold units are held together by lock-and-key mating or coupling connector members to form a one-dimension or a two-dimension mold assembly.

8. The mold assembly of claim 7, wherein said container member comprises a tapered ovoid cylindrical receptacle with an oval top side comprising an oval opening, a tapered ovoid cylindrical body side, and an oval bottom side, wherein the attachment means comprises two vertical female coupling connector members and two vertical male coupling connector members which are integrally molded to the upper portion of body side of the container, and wherein said removable lid member is oval and comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor.

9. The mold assembly of claim 8 wherein said removable lid comprising a central collar with a longitudinal slot is made of semi-rigid silicone rubber.

10. The mold assembly of claim 8 wherein said container member comprises a tapered circular cylindrical receptacle with a round top side comprising a circular opening, a tapered circular cylindrical body side, and a round bottom side.

11. The mold assembly of claim 10 wherein said removable lid comprising a central collar with a longitudinal slot is made of semi-rigid silicone rubber.

12. An article of manufacture comprising a plurality of modular mold units, instructions for use, and optionally a plurality of wooden or plastic sticks, wherein each said mold unit comprises a container member and a removable lid member, wherein said container member comprises an opening on the top side and attachment means comprising two or four lock-and-key coupling connector members on the body side, wherein said lid member comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor, and wherein said container member, said lid member, and said separate plastic stick are made of plasticizer-free, unadulterated, nonrecycled, heat-stable, microwave-transmissible plastic, and.

13. The article of claim 12 wherein said instructions for use indicate that: the molds can be used to save space in the freezer compartment; the molds can be safely used in a microwave oven for quickly, conveniently, and hygienically releasing the confections from the molds; and the way to determine the length of time to heat in a microwave oven; wherein said instructions for use are printed on one or more of: the package; the accompanying instruction flyer; and/or communicated via print and/or electronic mass media: newspapers, magazines, radio, television, interne, circulars, and the like, and wherein said instructions can be in words, or illustrative images and/or icons including in combination with words.

14. The method of claim 12, wherein said container member comprises a tapered ovoid cylindrical receptacle with an oval top side comprising an oval opening, a tapered ovoid cylindrical body side, and an oval bottom side.

15. The article of claim 14 wherein said removable lid comprising a central collar with a longitudinal slot is made of semi-rigid silicone rubber.

16. The article of claim 12 wherein said container member comprises a tapered circular cylindrical receptacle with a round top side comprising a circular opening, a tapered circular cylindrical body side, and a round bottom side.

17. The article of claim 16 wherein said removable lid comprising a central collar with a longitudinal slot is made of semi-rigid silicone rubber.

18. A method for production of frozen confections that allows the preparation of an exact number of frozen confections on a stick that are needed without causing extra dead space in the freezer compartment of a home refrigerator, and that allows a quick and convenient release of the frozen confections by a microwave oven, said method including the steps of:
(1) providing a plurality of modular mold units, wherein each said mold unit comprises a container member and a removable lid member; wherein said container member comprises an opening on the top side and attachment means comprising two or four lock-and-key coupling connector members on the body side, wherein said lid member comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor, and wherein said container member, said lid member, and said separate plastic stick are made of plasticizer-free, unadulterated, nonrecycled, heat-stable, microwave-transmissible plastic;
(2) hooking the desired number of modular mold units to one another using the lock-and key attachment means to form an assembly of mold units;
(3) inserting and securing a flat plastic or wooden stick into the slot opening of the central collar of each lid member if the lid provides said slot opening, and dividing said stick into a handle and an anchor,
(4) placing liquid confection material into the receptacles of the mold units;
(5) snuggly fitting the lids over the openings of the receptacles;
(6) placing the assembly of filled mold units into a freezer and waiting until the liquid confection material is frozen;
(7) removing the assembly of mold units containing the frozen confections from the freezer, unhooking and setting aside the desired number of mold units containing the frozen confections for immediate consumption;
(8) returning the smaller assembly of unused units to the freezer compartment; and
(9) heating the frozen confections in the set-aside molds using a microwave oven to quickly and conveniently release the frozen confections from the molds.

19. The method of claim 17, wherein said container member comprises a tapered ovoid cylindrical receptacle with an oval top side comprising an oval opening, a tapered ovoid cylindrical body side, and an oval bottom side.

20. The method of claim 18, wherein said container member comprises a tapered circular cylindrical receptacle with a round top side comprising a circular opening, a tapered circular cylindrical body side, and a round bottom side.
